(19) United States
(12) Patent Application Publication
(10) Pub. No.: US 2026/0319498 A1
(43) Pub. Date: Oct. 15, 2026

(54) NAVIGATION SATELLITE SYSTEM INDEPENDENT CONTROL DEVICE FOR UNMANNED VEHICLES AND METHOD THEREOF

(71) Applicant: aiseed Inc., Taipei City (TW)

(72) Inventors: TSUNG-YUAN WANG, Taipei City (TW); CHIH-TING LI, Taipei City (TW); TZU-HSIANG HUNG, Taipei City (TW); BO-RONG LAI, Taipei City (TW); YI-JYUN WU, Taipei City (TW)

(21) Appl. No.: 19/570,418

(22) Filed: Mar. 18, 2026

(30) Foreign Application Priority Data
Apr. 9, 2025 (TW) 114113349

(51) Int. Cl. G05D 1/248; G01S 19/47; G05D 1/245; G05D 109/20; G06V 10/75; G06V 20/13; G06V 20/17

(52) U.S. Cl. CPC G05D 1/248; G01S 19/47; G05D 1/245; G05D 2109/20; G06V 10/751; G06V 20/13; G06V 20/17

(57) ABSTRACT

A navigation satellite system independent control device for unmanned vehicles includes a vehicle-side control unit, a vehicle-side global satellite positioning signal receiving unit, a computing unit, an inertial measurement unit, an image capture unit and a database. The vehicle-side global satellite positioning signal receiving unit is signal-connected to the vehicle-side control unit; the computing unit is signal-connected to the vehicle-side control unit; the inertial measurement unit is signal-connected to the computing unit; the image capture unit is signal-connected to the computing unit; and the database is signal-connected to the computing unit. When an unmanned vehicle fails to receive positioning signals from satellites due to outdoor factors, the computing unit calculates correction signals by means of feature matching and the vehicle-side control unit calculates subsequent control signals using the correction signals, enabling the unmanned vehicle to complete a mission.

### REFERENCE TO RELATED APPLICATIONS

The present application is based on, and claims priority from, Taiwan application number 114113349, filed 2025 Apr. 9, the disclosure of which is hereby incorporated by reference herein in its entirety.

### BACKGROUND OF THE INVENTION

### Field of the Invention

The present invention relates to a navigation satellite system independent control device for unmanned vehicles and a method thereof and, more particular, to a motion control device that computes correction signals by means of image matching, so as to obtain control signals, and a method thereof.

### Description of the Prior Art

Currently common systems such as Global Positioning System (GPS), Globalnaya Navigatsionnaya Sputnikovaya Sistema (GLONASS), BeiDou Navigation Satellite System (BDS), and Galileo can all be regarded as Global Navigation Satellite Systems (GNSS).

Known unmanned aerial vehicles (UAVs) (or unmanned vehicles) mainly rely on GPS or GNSS, requiring more than four satellites to achieve precise positioning. However, in many outdoor circumstances, such as modern battlefields, long-range wireless satellite signals are susceptible to interference. This may cause UAVs to fail their missions, as the UAVs cannot locate themselves or calculate their own flight status.

In summary, how to realize positioning and flight status estimation of UAVs independent of the positioning of global navigation satellite systems has become an urgent issue requiring improvement and innovation in the industry.

### SUMMARY OF THE INVENTION

In view of the above shortcomings of the prior art, improvements and innovations are desired. After years of research and experiments, the navigation satellite independent motion control device for unmanned vehicles and method thereof according to the present invention have finally been successfully developed.

The present invention provides a navigation satellite independent motion control device for unmanned vehicles. The motion control device includes a vehicle-side control unit, a vehicle-side global satellite positioning signal receiving unit, a computing unit, an inertial measurement unit, an image capture unit and a database. The vehicle-side global satellite positioning signal receiving unit is signal-connected to the vehicle-side control unit; the computing unit is signal-connected to the vehicle-side control unit; the inertial measurement unit is signal-connected to the computing unit; the image capture unit is signal-connected to the computing unit; and the database is signal-connected to the computing unit.

The computing unit is provided with an inertial measurement computing module and a satellite image computing module.

The inertial measurement computing module is configured as an artificial neural network or a neural network; the satellite image computing module is provided with a feature extraction algorithm.

The inertial measurement unit is configured as a combination of an accelerometer and a gyroscope; the image capture unit is configured as a video camera or a still camera.

The navigation satellite system independent control device for unmanned vehicles further includes a barometer and a magnetometer which are signal-connected to the computing unit.

The navigation satellite system independent control device for unmanned vehicles further includes a power source which is electrically connected to the vehicle-side control unit.

The present invention further provides a navigation satellite system independent control method for unmanned vehicles includes the following steps:
step S01: changing a navigation mode: when a vehicle-side global satellite positioning signal receiving unit fails to receive positioning signals, a vehicle-side control unit activates a computing unit so that the computing unit replaces the vehicle-side global satellite positioning signal receiving unit;
step S02: reading measurement values: an inertial measurement unit outputs measurement values of angular velocity and acceleration of an unmanned vehicle to the computing unit;
step S03: generating navigation signals: the computing unit calculates a local displacement using the measurement values, and the local displacement is added to initial longitude and latitude coordinates of the unmanned vehicle when the unmanned vehicle starts operating, thus forming navigation signals;
step S04: capturing images: an image capture unit captures images and provides the images to the computing unit;
step S05: extracting features: the computing unit extracts and marks features in the images;
step S06: extracting features of satellite images: the computing unit extracts and marks features in satellite images stored in a database;
step S07: matching features: the computing unit performs feature matching between the features of captured images and the features of satellite images;
step S08: aligning features: the computing unit matches the features of the satellite images with those of the captured images, and projects the captured images onto the satellite images to align the corresponding features of the captured images and the satellite images, thereby determining the location of the unmanned vehicle on the satellite images;
step S09: correcting a flight status: the computing unit uses the satellite images to calculate the longitude and latitude coordinates of the unmanned vehicle at the time of image capture, and then, in combination with time stamps of the images captured by the image capture unit, the computing unit calculates correction signals using the local displacement from step S03; the correction signals are transmitted to the vehicle-side control unit, and the vehicle-side control unit calculates subsequent control signals using the correction signals, where the control signals are used to enable the unmanned vehicle to adjust the flight status.

In step S03, the computing unit uses an artificial neural network or a neural network. The artificial neural network or the neural network is trained in the following ways: a barometer provides an altitude of the unmanned vehicle to the computing unit; a magnetometer provides a heading angle of the unmanned vehicle to the computing unit; the artificial neural network or neural network formulates a loss function based on the measurement values, the aforementioned altitude and heading angle, and the corresponding ground-truth labels, and uses an Adam optimizer to find the global minimum of the loss function.

The absolute initial latitude and longitude coordinates are either manually input values or positioning signals received by the vehicle-side global satellite positioning signal receiving unit when the unmanned vehicle starts operating.

To sum up, according to the navigation satellite system independent control device for unmanned vehicles and the method thereof described herein, when the unmanned vehicle fails to receive positioning signals from satellites (GPS or GNSS) during operation, the computing unit calculates correction signals by matching the images captured by the image capture unit with the satellite images stored in the database, and the vehicle-side control unit calculates subsequent control signals using the correction signals.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 is a schematic diagram of a navigation satellite system independent control device for unmanned vehicles according to the present invention.

FIG. 2 is a schematic flow chart of a navigation satellite system independent control method for unmanned vehicles according to the present invention.

### DETAILED DESCRIPTION OF THE INVENTION

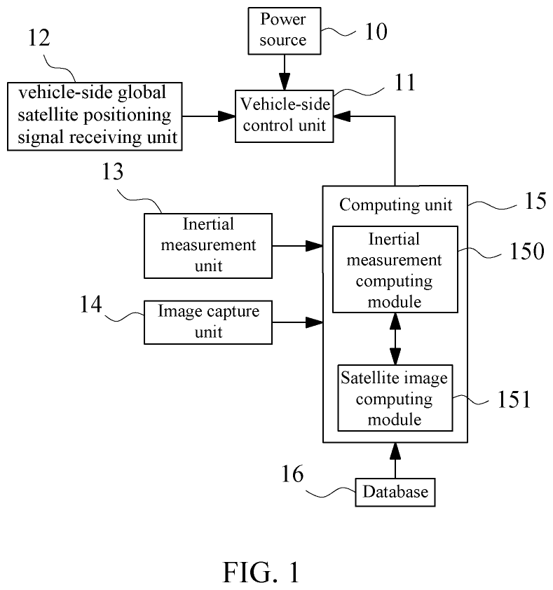

Referring to FIG. 1, the schematic diagram of a navigation satellite system independent control device for unmanned vehicles according to the present invention is shown in FIG. 1. As shown in the figure, the navigation satellite system independent control device for unmanned vehicles includes a power source 10, a vehicle-side control unit 11, a vehicle-side global satellite positioning signal receiving unit 12, an inertial measurement unit 13, an image capture unit 14, a computing unit 15, and a database 16. The power source 10, the vehicle-side control unit 11, the vehicle-side global satellite positioning signal receiving unit 12, the inertial measurement unit 13, the image capture unit 14, the computing unit 15 and the database 16 are mounted inside an unmanned vehicle. The unmanned vehicle may be an aerial unmanned vehicle, a land-based unmanned vehicle, a water-based unmanned vehicle, or an underwater unmanned vehicle, but is not limited thereto. In the present invention, an aerial unmanned vehicle is taken as an example for illustration, but the present invention is not limited thereto.

The vehicle-side control unit 11 is signal-connected to the vehicle-side global satellite positioning signal receiving unit 12, or the vehicle-side control unit 11 receives manually input values as absolute initial latitude and longitude coordinates.

The inertial measurement unit 13 is signal-connected to the computing unit 15. The inertial measurement unit 13 is a device for measuring the three-axis attitude angle (or angular velocity) and acceleration of an object. The inertial measurement unit 13 is a combination of an accelerometer and a gyroscope.

The image capture unit 14 is signal-connected to the computing unit 15. The image capture unit 14 is a video camera or a still camera.

The computing unit 15 is signal-connected to the inertial measurement unit 13 and the vehicle-side control unit 11. The computing unit 15 is provided with an inertial measurement computing module 150 and a satellite image computing module 151. The inertial measurement computing module 150 is signal-connected to the satellite image computing module 151. The inertial measurement computing module 150 is configured as an artificial neural network or a neural network. The satellite image computing module 151 is provided with a feature extraction algorithm.

The navigation satellite system independent control device for unmanned vehicles includes a barometer and a magnetometer (not shown) which are arranged inside the unmanned vehicle and signal-connected to the computing unit 15. The barometer is configured to calculate the altitude (flight altitude) of the unmanned vehicle, and the magnetometer is configured to obtain the heading angle of the unmanned vehicle.

The database 16 is signal-connected to the computing unit 15. The database 16 stores satellite images.

The power source 10 is electrically connected to the vehicle-side control unit 11, so as to supply electric energy to the vehicle-side global satellite positioning signal receiving unit 12, the inertial measurement unit 13, the image capture unit 14, the computing unit 15 and the database 16 by means of the vehicle-side control unit 11.

When the unmanned vehicle is in operation (in flight), if the vehicle-side global satellite positioning signal receiving unit 12 fails to receive positioning signals from satellites, the vehicle-side control unit 11 activates the computing unit 15 so that the computing unit 15 replaces the vehicle-side global satellite positioning signal receiving unit 12.

The inertial measurement unit 13 outputs measurement values of angular velocity and acceleration to the inertial measurement computing module 150.

The image capture unit 14 continuously captures images at an angle perpendicular to the ground and provides the captured images to the computing unit 15.

The satellite image computing module 151 extracts and marks features in the images captured by the image capture unit 14, including sufficiently representative features such as features on road contours, features on building edges and corners, and features on the edges of land-water boundaries.

The satellite image computing module 151 extracts and marks features in the satellite images from the database 16; then, feature matching is performed between the images with features and the satellite images with features, and each match generates a score indicating the degree of matching.

After the feature matching between the satellite images and the captured images is completed, the computing unit 15 projects the captured images onto the satellite images to align the corresponding features of the captured images and the satellite images, and then the location of the unmanned vehicle on the satellite images can be determined.

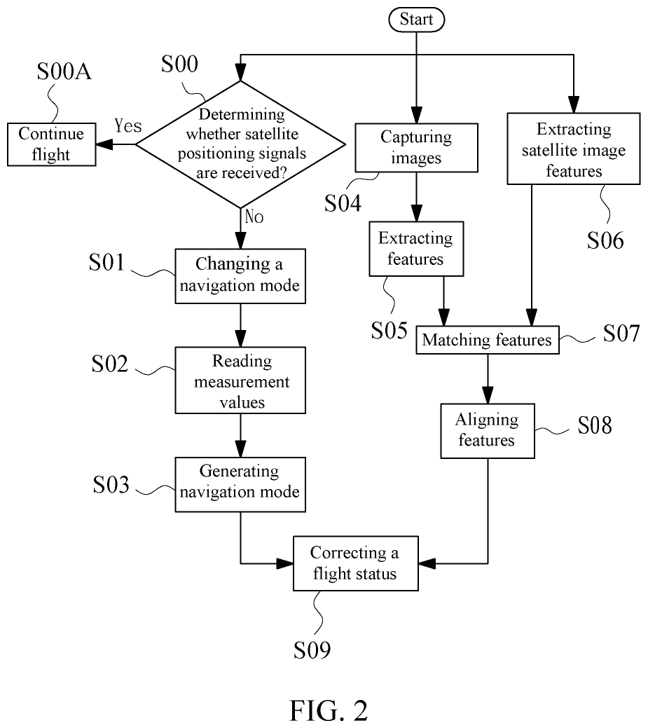

Referring to FIG. 2, the schematic flow chart of a navigation satellite system independent control method for unmanned vehicles according to the present invention is shown in FIG. 2. As shown in the figure, the navigation satellite system independent control method for unmanned vehicles includes the following steps:

Step S00: determining whether satellite positioning signals are received: determining if the vehicle-side global satellite positioning signal receiving unit 12 receives positioning signals from satellites; if not, proceeding to step S01; if yes, proceeding to step S00A.

Step S00A: continuing flight: the vehicle-side global satellite positioning signal receiving unit 12 continuously receives positioning signals from satellites and transmits the positioning signals to the vehicle-side control unit 11; and then the vehicle-side control unit 11 calculates subsequent control signals using the positioning signals, and the unmanned vehicle completes a mission according to the control signals.

Step S01: changing a navigation mode: the vehicle-side global satellite positioning signal receiving unit 12 fails to receive positioning signals from the satellites, and the vehicle-side control unit 11 activates the computing unit 15 so that the computing unit 15 replaces the vehicle-side global satellite positioning signal receiving unit 12.

Step S02: reading measurement values: during the operation of the unmanned vehicle, the inertial measurement unit 13 outputs measurement values of angular velocity and acceleration to the inertial measurement computing module 150.

Step S03: generating navigation signals: the artificial neural network (or neural network) of the inertial measurement computing module 150 directly reads the measurement values from step S02 to calculate a local displacement of the unmanned vehicle from the start of operation to the time of calculation.

In step S03, the artificial neural network (or neural network) must undergo training to calculate navigation signals. The artificial neural network (or neural network) is trained in the following way: the barometer provides the altitude of the unmanned vehicle to the computing unit 15; the magnetometer provides the heading angle of the unmanned vehicle to the computing unit 15; the artificial neural network (or neural network) of the inertial measurement computing module 150 uses the measurement values described in step S02 and uses the Adam Optimizer to find the global minimum in a loss function.

To further elaborate that: the artificial neural network (or neural network) of the inertial measurement computing module 150 derives an inferred local displacement from the measurement values described in Step S02, using the aforementioned altitude, heading angle, acceleration, and angular velocity and then calculates a difference between the inferred value and a ground-truth label (the ground-truth label is an accurate observation obtained by measuring the location of the unmanned vehicle with outdoor instruments, and this is the corresponding position variation in three-dimensional space calculated from GPS (or GNSS) coordinates). In this process, the loss function defines the method for calculating the difference, and the model learning rate is adjusted by the Adam Optimizer to find the global minimum of the loss function.

Step S04: capturing images: the image capture unit 14 continuously captures images (videos or photos) at an angle perpendicular to the ground, and the captured images captured by the image capture unit 14 are provided to the computing unit 15.

Step S05: extracting features: the satellite image computing module 151 extracts and marks features in the images captured by the image capture unit 14, such as sufficiently representative features like features on road contours, features on building edges and corners, and features on the edges of land-water boundaries.

Step S06: extracting satellite image features: the satellite image computing module 151 extracts and marks features in satellite images stored in the database 16.

In step S06, relevant satellite images need to be established in advance in the database 16. Satellite images of a mission execution range of the unmanned vehicle are stored in advance in the database 16 for query and comparison. Considering that the altitude of the unmanned vehicle affects the scale of satellite images and that ground landscape changes with seasons, satellite images collected at multiple scales and across different seasons are stored in the database 16. Satellite images of the mission execution range are divided into multiple images instead of using a single map to cover the entire area. The four corners of each satellite image stored in the database 16 are marked with longitude and latitude coordinates, which are key information for positioning the unmanned vehicle in subsequent steps.

Step S07: matching features: the computing unit 15 performs feature matching between the images with the features from step S05 and the satellite images with the features from step S06, and each match generates a score indicating the degree of matching. If a satellite image with the highest matching score meets the self-defined minimum threshold for the number of matched features, it is inferred that the location of the unmanned vehicle is within the range of this satellite image. The number varies with application scenarios. In scenarios requiring high precision, this threshold can be raised to strictly filter the matching results.

Step S08: aligning features: after the feature matching between the satellite images and the captured images is completed, the computing unit 15 projects the captured images onto the satellite images to align the corresponding features of the captured images and the satellite images, and then the location of the unmanned vehicle on the satellite images can be determined. Since the four corners of each satellite image have longitude and latitude coordinates.

Step S09: correcting a flight status: the satellite image computing module 151 uses the satellite images to calculate the longitude and latitude coordinates of the unmanned vehicle at the time of image capture, and then, in combination with the time stamps of the images captured by the image capture unit 14, the computing unit 15 calculates correction signals using the local displacement from step S03; the correction signals are transmitted to the vehicle-side control unit 11, and the vehicle-side control unit 11 calculates subsequent control signals using the correction signals. The control signals are used to enable the unmanned vehicle to adjust the flight status.

Steps S01 to S03, steps S04 and S05, and step S06 described above may be performed simultaneously or sequentially.

To sum up, according to the navigation satellite system independent control device and method for unmanned vehicles, when the vehicle-side global satellite positioning signal receiving unit 12 fails to receive positioning signals, the vehicle-side control unit 11 activates the computing unit 15; the computing unit 15 calculates correction signals using the measurement values from the inertial measurement unit 13, the images captured by the image capture unit 14, and the satellite images stored in the database 16; and the vehicle-side control unit 11 calculates subsequent control signals using the correction signals, enabling the unmanned vehicle to complete a mission according to the control signals.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A navigation satellite system independent control device for unmanned vehicles, comprising:
a vehicle-side control unit;
a vehicle-side global satellite positioning signal receiving unit signal-connected to the vehicle-side control unit;
a computing unit signal-connected to the vehicle-side control unit;
an inertial measurement unit signal-connected to the computing unit;
an image capture unit signal-connected to the computing unit; and
a database signal-connected to the computing unit.

2. The navigation satellite system independent control device for unmanned vehicles of claim 1, wherein the computing unit is provided with an inertial measurement computing module and a satellite image computing module.

3. The navigation satellite system independent control device for unmanned vehicles of claim 2, wherein the inertial measurement computing module is configured as an artificial neural network or a neural network; the satellite image computing module is provided with a feature extraction algorithm.

4. The navigation satellite system independent control device for unmanned vehicles of claim 1, wherein the inertial measurement unit is configured as a combination of an accelerometer and a gyroscope; the image capture unit is configured as a video camera or a still camera.

5. The navigation satellite system independent control device for unmanned vehicles of claim 1, further comprising a barometer and a magnetometer which are signal-connected to the computing unit.

6. The navigation satellite system independent control device for unmanned vehicles of claim 1, further comprising a power source which is electrically connected to the vehicle-side control unit.

7. A navigation satellite system independent control method for unmanned vehicles, comprising the following steps:
step S01: changing a navigation mode: when a vehicle-side global satellite positioning signal receiving unit fails to receive positioning signals, a vehicle-side control unit activates a computing unit so that the computing unit replaces the vehicle-side global satellite positioning signal receiving unit;
step S02: reading measurement values: an inertial measurement unit outputs measurement values of angular velocity and acceleration of an unmanned vehicle to the computing unit;
step S03: generating navigation signals: the computing unit calculates a local displacement using the measurement values, and the local displacement is added to initial longitude and latitude coordinates of the unmanned vehicle when the unmanned vehicle starts operating, thus forming navigation signals;
step S04: capturing images: an image capture unit captures images and provides the images to the computing unit;
step S05: extracting features: the computing unit extracts and marks features in the images;
step S06: extracting features of satellite images: the computing unit extracts and marks features of satellite images stored in a database;
step S07: matching features: the computing unit performs feature matching between features of captured images and the features of satellite images;
step S08: aligning features: the computing unit matches the features of the satellite images with those of the captured images, and projects the captured images onto the satellite images to align the corresponding features of the captured images and the satellite images, thereby determining the location of the unmanned vehicle on the satellite images;
step S09: correcting a flight status: the computing unit uses the satellite images to calculate the longitude and latitude coordinates of the unmanned vehicle at the time of capturing the images, and then, in combination with time stamps of the images captured by the image capture unit, the computing unit calculates correction signals using the local displacement from step S03; the correction signals are transmitted to the vehicle-side control unit, and the vehicle-side control unit calculates subsequent control signals using the correction signals, where the control signals are used to enable the unmanned vehicle to adjust the flight status.

8. The navigation satellite system independent control method for unmanned vehicles of claim 7, wherein in step S03, the computing unit uses an artificial neural network or a neural network, and the artificial neural network or the neural network is trained in the following way: a barometer provides an altitude of the unmanned vehicle to the computing unit; a magnetometer provides a heading angle of the unmanned vehicle to the computing unit; the artificial neural network or the neural network formulates a loss function based on the measurement values, the altitude and heading angle, and corresponding ground-truth labels, and uses an Adam optimizer to find the global minimum of the loss function.

9. The navigation satellite system independent control method for unmanned vehicles of claim 7, wherein in step S06, relevant satellite images need to be established in advance in the database, satellite images of a mission execution range of the unmanned vehicle are stored in advance in the database for query and comparison.

10. The navigation satellite system independent control method for unmanned vehicles of claim 7, wherein the absolute initial latitude and longitude coordinates are either manually input values or the positioning signals received by the vehicle-side global satellite positioning signal receiving unit when the unmanned vehicle starts operating.
